(19) United States
(12) Patent Application Publication
(10) Pub. No.: US 2013/0316826 A1
(43) Pub. Date: Nov. 28, 2013

(54) HAPTIC-SIMULATION HOME-VIDEO GAME

(71) Applicant: Ofer LEVANON, Kfar Saba (IL)

(72) Inventor: Ofer LEVANON, Kfar Saba (IL)

(21) Appl. No.: 13/958,576

(22) Filed: Aug. 4, 2013

Related U.S. Application Data
(63) Continuation-in-part of application No. 12/624,145, filed on Nov. 23, 2009, now abandoned.

(51) Int. Cl. A63F 13/06

(52) U.S. Cl. CPC A63F 13/06
USPC 463/36; 29/428

(57) ABSTRACT

A home-driving-simulator kit having providing multi-modal feedback in a fully rotatable cockpit in accordance with gaming feedback data

The present invention relates to home video games, and, in particular is concerned with a haptic-simulation seat for a game user.

It is know that home video-games are moving towards providing users with a more realistic gaming experiences by way of multiple forms of feedback that appeal to as many of the senses as possible. Visual and audio simulations in video games have been augmented by haptic simulations. Sony “Playstation” and Nintendo “64 Rumble Pack” 64” provide haptic feedback in the form of vibrations when users fire a gun or are hit by enemy fire. Microsoft's “Force Feedback Joystick” and “Immersion One” provide more sophisticated forms of haptic simulation via a force-feedback joy stick and Logitech's “G25 and G27 force-feedback “Racing Wheel”. Although these products provide haptic simulation by way of a force-feedback joysticks and racing wheels, they provide very limited, if it all, haptic simulation of the seat used by the user. U.S. Pat. Nos. 6,431,989 6,152,828 and 5,951,018 teach a gaming systems providing haptic simulation for a user's seat; however, these systems utilize specialized equipment and because of their sophistication are expensive and unsuitable for the average home user.

Therefore, it would be advantageous for home-video games to be equipped with haptic-simulation seats providing haptic simulation of the user's gaming activities and the gaming conditions resulting from those activities.

### SUMMARY OF THE INVENTION

The present invention is a home-video game including a haptic-simulation seat operative in accordance with user gaming data generated by a forced-feedback gaming console and also gaming-feedback data representing resulting gaming conditions utilized by the force-feedback gaming console.

According to the teachings of the present invention there is provided haptic-simulation, home-video game comprising: a) a gaming-system including i) a game processor configured to generate gaming-feedback data based on a video-game user's gaming activities; ii) a display screen operative to display the gaming-feedback data generated by the game processor; iii) a force-feedback gaming-console including a first data-to-motion converter, the force-feedback gaming-console configured to generate haptic simulations of gaming conditions displayed on the display screen based on the gaming-feedback data received by the first data-to-motion converter; and b) a haptic-simulation seat including a second data-to-motion converter, the haptic-simulation seat being configured to generate haptic simulations based on the gaming-feedback data flow utilized by the force-feedback gam-ing-console.

According to a further feature of the present invention the haptic-simulation seat is configured to generate hap-tic-simulations in accordance with the user's gaming activities by way of a data flow path configured to transfer gaming data generated by the force-feedback gaming console to the second data-to-motion converter.

According to a further feature of the present invention the haptic-simulation, home-video game is implemented as a driving game.

According to a further feature of the present invention the haptic-simulation, home-video game of claim 1, wherein the haptic-simulation is at least one motion chosen from the group of rotating, vibrating, rocking and tilting.

According to a further feature of the present invention the tilting is in at least one direction chosen from the group consisting of forwards, backwards, and sideways.

According to a further feature of the present invention the gaming-console includes at least one user-interface chosen from the group consisting of steering-wheel, joy stick, shift-mechanism and pedal.

According to a further feature of the present invention the pedal includes at least of one pedal chosen from the group consisting of a brake pedal, acceleration pedal, and clutch pedal.

There is also provided according to the teachings of the present invention method method for providing haptic-simulation data to a haptic-simulation seat used by a video game user comprising: (a) providing a video-gaming system including: i) a game processor operative to generate gaming-feedback data based on gaming activities of the video game user; ii) a display screen; iii) a force-feedback gaming-con-sole that includes a first data-to-motion converter, the force-feedback gaming-console being configured to generate hap-tic-simulations of gaming-conditions presented on the display screen based on the gaming feedback data received by the first data-to-motion converter; (b) providing a haptic-simulation seat including a second data-to-motion converter, the haptic-simulation seat being configured to also generate haptic-simulations of the gaming activities appearing on the display screen; and (c) establishing a path for data flow of the gaming-feedback data between the video-gaming system and the haptic-simulation seat so as to enable the haptic-simulation seat to generate the haptic simulations based on the gaming feedback data received by the first data-to-motion converter.

According to a further feature of the present invention the second data-to-motion converter of the haptic-simulation seat receiving gaming data generated by the user on the the force-feedback gaming console so that the seat haptically simulates the gaming activities.

According to a further feature of the present invention the establishing a path for data flow of the gaming-feedback data between the video-gaming system and the hap-tic-simulation seat includes plugging a detachable data flow line into a data port disposed in the video-gaming system.

According to a further feature of the present invention the video gaming system is implemented as a driving game.

According to a further feature of the present invention the generation of haptic-simulations includes motion chosen from the group consisting of rotating, vibrating, rocking and tilting.

According to a further feature of the present invention the tilting is in at at least one of directions chosen from the group consisting of forwards, backwards, and sideways.

According to a further feature of the present invention the generation of haptic-simulations includes tilting in any one or combination of directions chosen from the group consisting of forwards, backwards, and sideways.

According to a further feature of the present invention the generation of haptic-simulations of the haptic-simulation seat is further based on receiving data from at least one mechanism included in the gaming-console chosen from the group consisting of a steering wheel, joystick, acceleration pedal, braking pedal, clutch pedal, and shifting mechanism.

There is also provided according to the teachings of the present invention a method for providing haptic-simulation data to a haptic-simulation seat used by a video game user comprising: (a) providing a video-game including: a force-feedback gaming-console configured to generate gaming data of a user using the console; (b) providing a haptic-simulation seat including a data-to-motion converter configured to generate haptic-simulations of the gaming activities of the videogame user based on the gaming data; and (c) establishing a path for data flow of the gaming-data between the force-feedback gaming console and the haptic-simulation seat so as to enable the haptic-simulation seat to generate the haptic simulations based on the gaming data received by the data-to-motion converter.

According to a further feature of the present invention the generation of haptic-simulations of the haptic-simulation seat is further based on receiving data from at least one mechanism included in the gaming-console chosen from the group consisting of a steering wheel, joystick, acceleration pedal, braking pedal, clutch pedal, and shifting mechanism.

There is a also provided according to the teachings of the present invention a haptic-simulation, home-video game comprising: a) a force-feedback gaming-console configured to generate gaming data representing gaming activities of a user using the console; and b) a haptic-simulation seat configured to generate haptic simulations of the gaming actives of the user using the force-feedback gaming console based on the gaming data generated by the force feedback gaming console.

According to a further feature of the present invention the gaming-console includes at least one user-interface chosen from the group consisting of steering-wheel, joy stick, shift-mechanism and pedal.

According to a further feature of the present invention the pedal includes at least of one pedal chosen from the group consisting of a brake pedal, acceleration pedal, and clutch pedal.

### BRIEF DESCRIPTION OF THE DRAWINGS

The invention is herein described, by way of example only, with reference to the accompanying drawings:

FIG. 1 is a schematic, side view of home-video game its various components.

FIG. 2 is a schematic, side view of the haptic-simu-lation seat depicting the vertical movement of the chair as one form of haptic simulation.

FIGS. 3 and 4 a schematic side view of the haptic-simulation seat depicting forwards and backwards tilting motion as an additional form of haptic simulation.

FIGS. 5 and 6 are schematic, back views of the haptic-simulation seat depicting sideway tilting as an additional form of haptic simulation.

FIG. 7 is a second implementation of the system of FIG. 1 employing a wireless data link between the game processor and the haptic-simulation seat.

FIG. 8 is a flow chart depicting a gaming-feedback data flow configuration.

FIG. 9 is a flow chart depicting a gaming-feedback and a gaming-data flow configuration.

FIG. 10 is a schematic, side-view of a driver cockpit is rotatably mounted to a cockpit base, according to an embodiment;

FIG. 11 is a schematic, bottom view of a circular electrical connected mounted on the underside of a driver cockpit floor, according to embodiments;

FIG. 12 is a schematic side-view of a circular electrical groove disposed in a cockpit base for receiving the circular contact of FIG. 11, according to an embodiment;

FIG. 13 is a schematic, view depicting the rotational capability of the driver cockpit floor on the cockpit base, according to an embodiment;

FIG. 14 is a schematic, perspective view of driver cockpit floor and associated actuators providing motion in accordance with gaming feedback data, according to an embodiment, and

FIG. 15 is a flow chart of a method of construction of the home driving simulator according to an embodiment.

### DESCRIPTION OF THE PREFERRED EMBODIMENTS

The present invention is a home-video game equipped with a haptic-simulation seat configured to operate on gaming data generated by the user and gaming feedback data used by a force feedback gaming console.

By way of introduction following is a list of definitions of terms used throughout the document:

“Haptic simulation” refers to a form of simulation that interfaces with the user by the sense of touch by applying forces, vibrations and/or motions a user.

“Force-feedback gaming console” refers to a user interface supplying a force as feedback to a user's input.

The current home-video game is a video-gaming system in operative connection with a haptic-simulation seat on which the user sits while playing the game. The relevant elements, their operative interrelationship, and their various implementations may be better understood with reference to the following figures and the accompanying description.

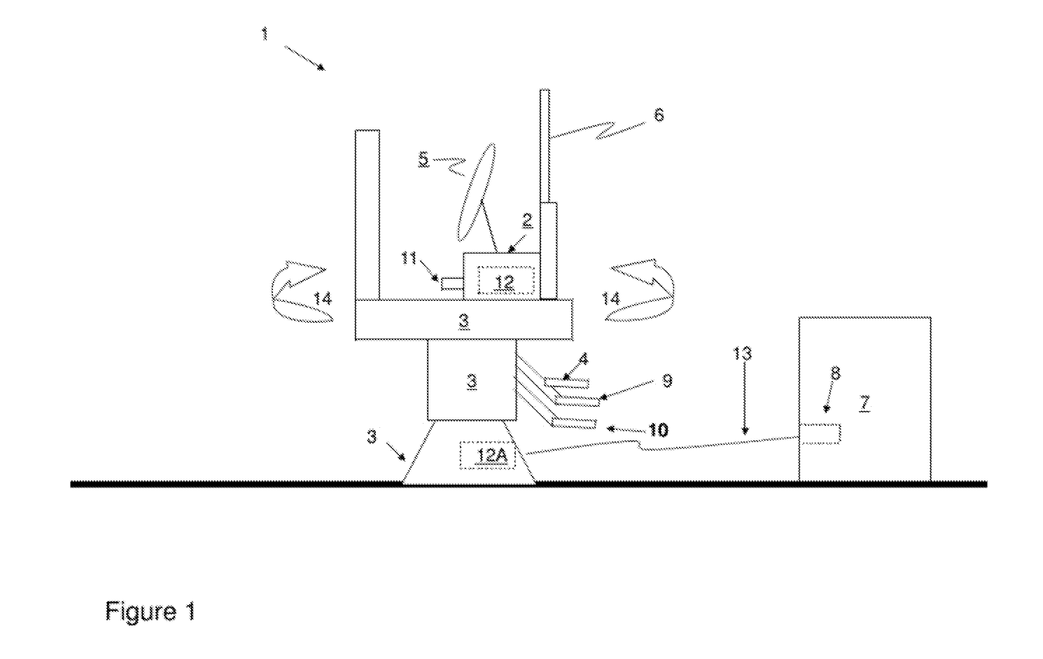

FIG. 1 depicts a schematic, side-view of home-video game 1 including force-feedback gaming console 2, haptic-simulation seat 3, steering wheel 5, display screen 6, game processor 7, data port 8, brake, accelerator 9, accelerator pedal 10, clutch pedal 4, shift mechanism 11, data-to-motion converters 12, and data cable 13.

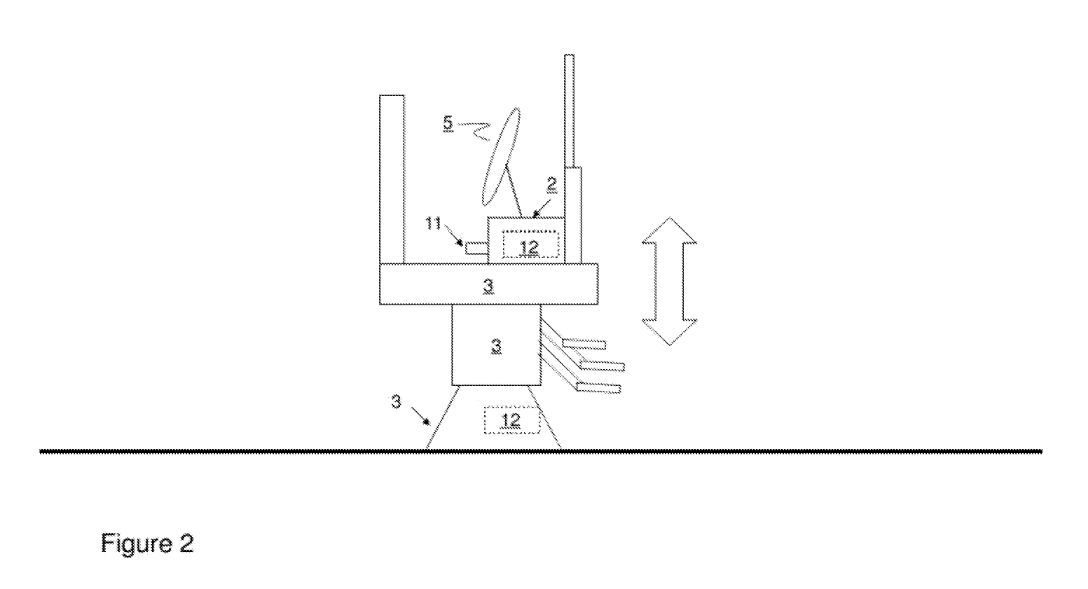

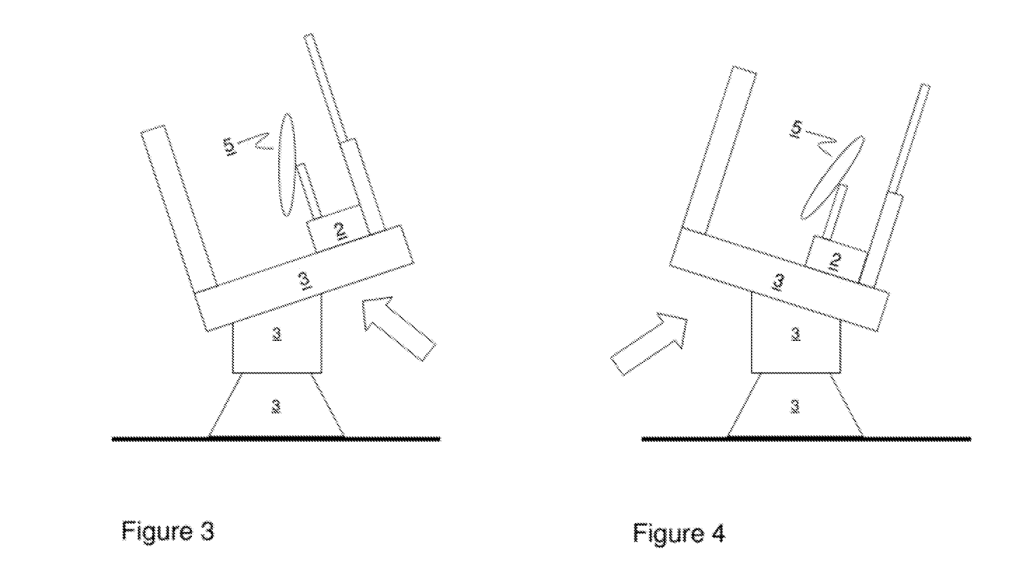

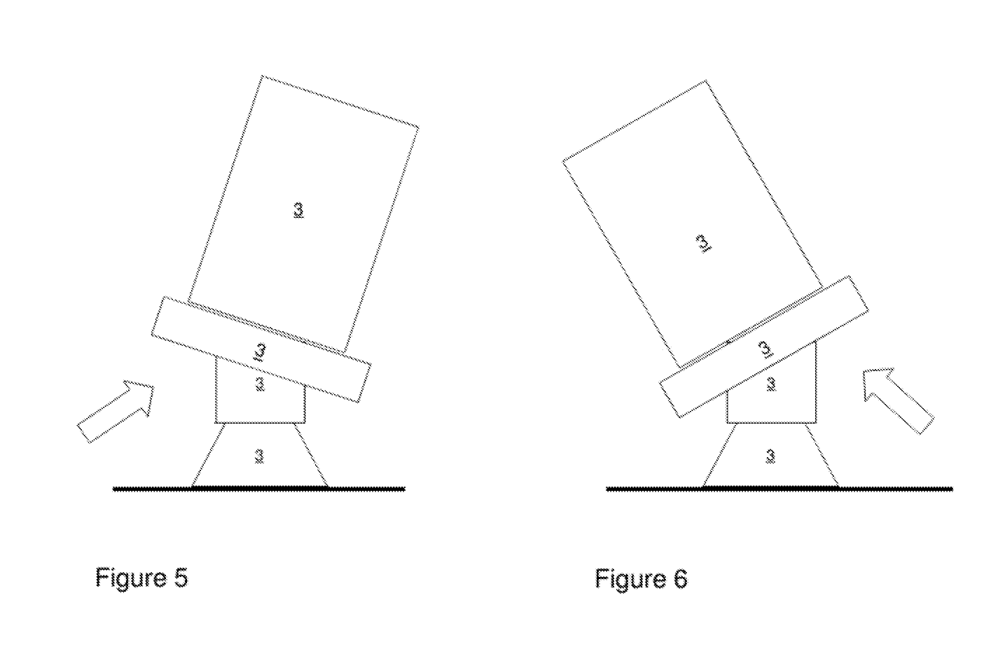

Haptic-simulation seat 3 include various motion generator mechanisms configured to rotate seat 3 in a horizontal plane, vibrate seat 3 vertically or horizontally, or tilt seat 3 forwards, backwards, sideways, rock or move seat 3 in any combination of these motions as shown in FIGS. 2-6. In a non-limiting exemplary embodiment the motion generator mechanisms are implemented by way of mechanism are motor and gear/pulley arrangements, hydraulic, pneumatic arrangements or any other motion producing arrangement know to those skilled in the art. The motion generator mechanisms move seat 3 in accordance with gaming data received by data-to-motion converter 12A. Force feedback-gaming console 2 includes various user interfaces such as steering wheel 5, brake, acceleration, and clutch pedals designated 9, 10 and 13 respectively, and in a variant embodiment, joy stick 17 (FIG. 17). Through these interfaces the user responds to gaining conditions generated by game processor 7. As is known in the art, game processor 7 generates gaming conditions in accordance with a gaming program loaded into a memory (not shown). In an exemplary non-limiting embodiment game processor 7 is implemented by way of a personal home computer as shown in FIG. 1; however, it should be noted that game processor 7 implemented as an online server or as a processor integrated into force-feedback gaming console 2 or any other data processing device are included within the scope of the current invention.

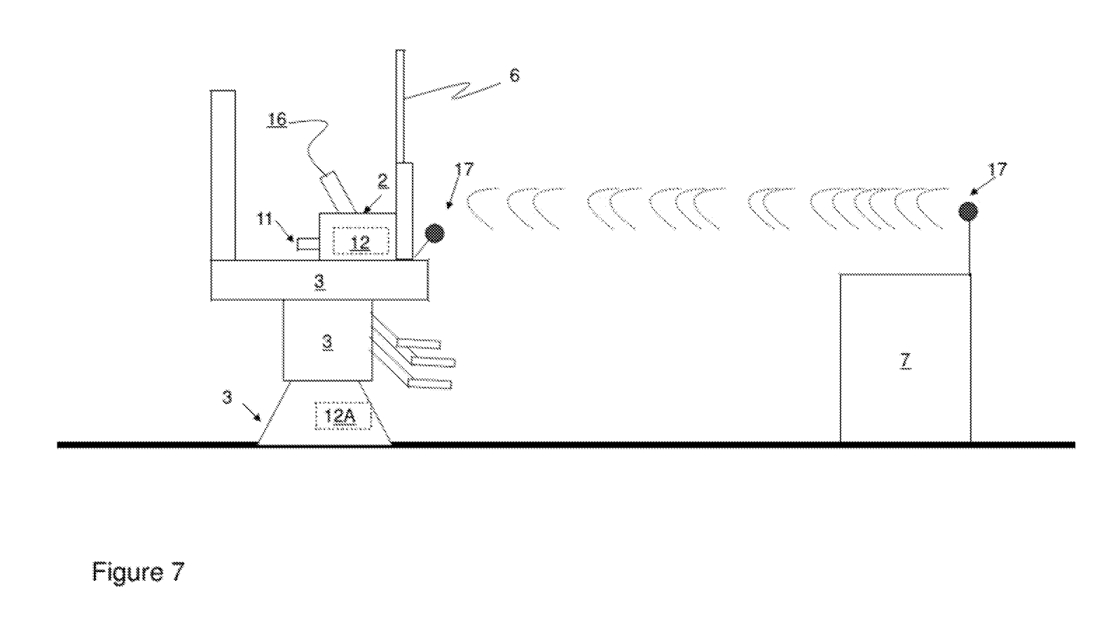

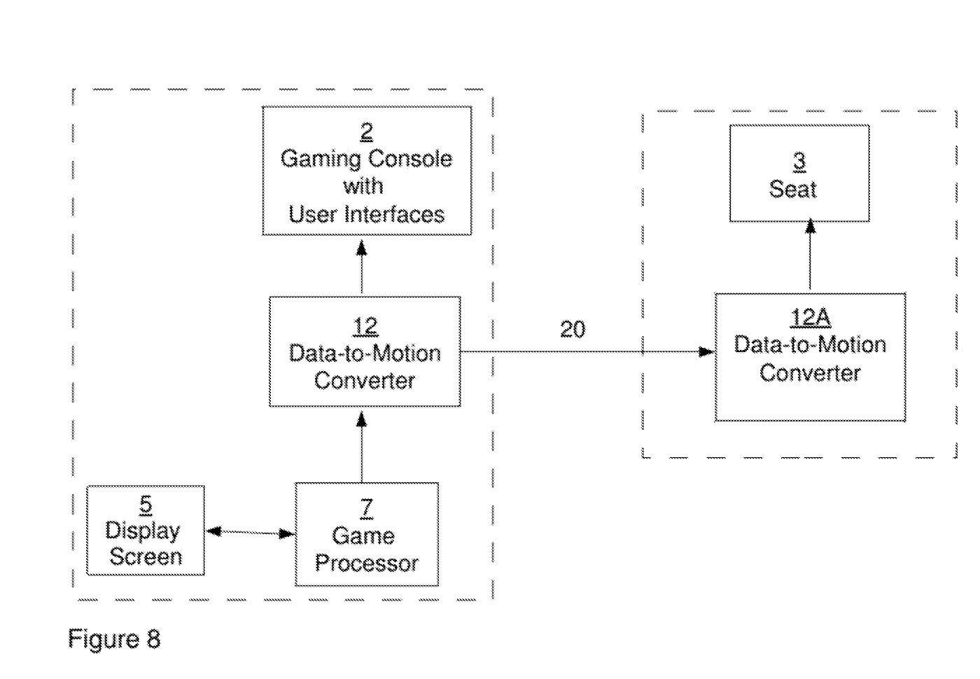

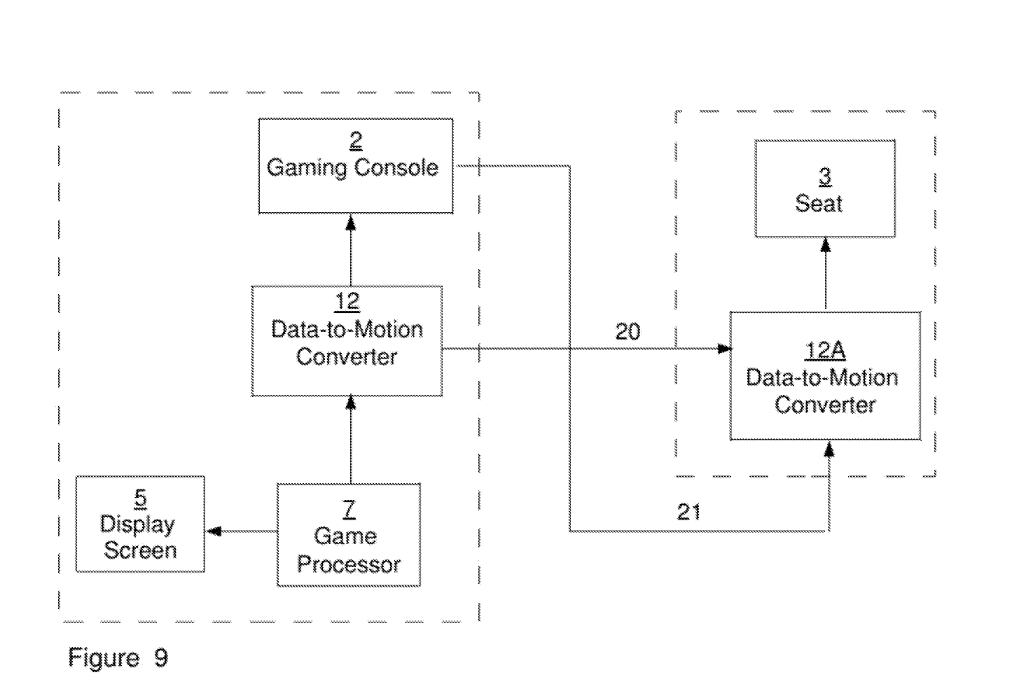

The various forms of user input is translated into gaming data 21 by way of a motion-to-data converter (not shown) and processed by processor 7 to generate gaming feedback data 20 (FIGS. 8 and 9) representing new gaming conditions. These gaming conditions conditions are displayed on display screen 6 and gaming feedback data 20 serves as the basis for the force-feedback effects generated by force-feedback gaming console 2 by way of data-to-motion converter 12. The current invention utilizes this gaming feedback data 20 to create the haptic-simulations of haptic simulation seat 3. By way of example, gaming feedback data 20 responsible for vibrating steering wheel 5 is also responsible for vibrating seat 3 a second data-to-motion converter 12A. Gaming feedback data 20 responsible for applying a torque to steering wheel 5 is also directed to data-to-motion converter 12A to generate a corresponding haptic effect in seat 3. It should be noted that the particular nature of the haptic-simu-lation of seat 3 is a function of both the nature of gaming feedback data 20, FIG. 8, and the motion-generator mechanism configuration. The same gaming feedback data 20 responsible for the force feedback effects of gaming console 2 is also responsible for a wide variety of haptic simulations of seat 3. By way of example, gaming feedback data 20 responsible for applying a torque to steering wheel 5 can also initiate a corresponding rotation in the same direction, a reverse rotation, tilting or even rotating seat 3 while tilting depending on the configuration of various motor, gear, and/or pulley arrangements known to those skilled in the art. All forms of haptic simulation emulating from gaming feedback data 20 also responsible for the force feedback effects of gaming console 2 are included within the scope of the present invention. Furthermore configurations in which haptic seat simulations are generated from a plurality of data-to-motion converters 12A receiving gaming feedback data 20 are also included in the scope of the present invention. FIG. 8 depicts the above-described gaming feedback data flow path. It should be noted that a gaming-feedback flow path between gaming system and data-to-motion converter 12A of seat 3 is implemented as data cable 13, FIG. 1, in an exemplary embodiment; however, FIG. 7 depicts a gaming-feedback data flow path implemented by way of a wireless connection 17 also included within the scope of the current invention. Furthermore, the gaming-feedback data flow path implemented by way of a fixed data flow path or by way of a detachable cable configured to plug into port 8 is also included within the scope of the current invention.

The current invention teaches another feature in which the gaming activities of the user are simulated haptically in seat 3. By way of several examples, a user turns steering wheel 5 and the seat 3 accordingly rotates in the opposite direction so as to simulate the effects of driving. Likewise, a user applies pressure to brake pedal 9 and seat 3 synchronously tilts forwards or when the user applies pressure to acceleration pedal 10 seat 3 responds by tilting backwards accordingly. This functionality is accomplished by directing gaming data 21 generated by gaming console 2 to data-to-motion converter 12A in addition to directing it to game processor 7 as shown in FIG. 9.

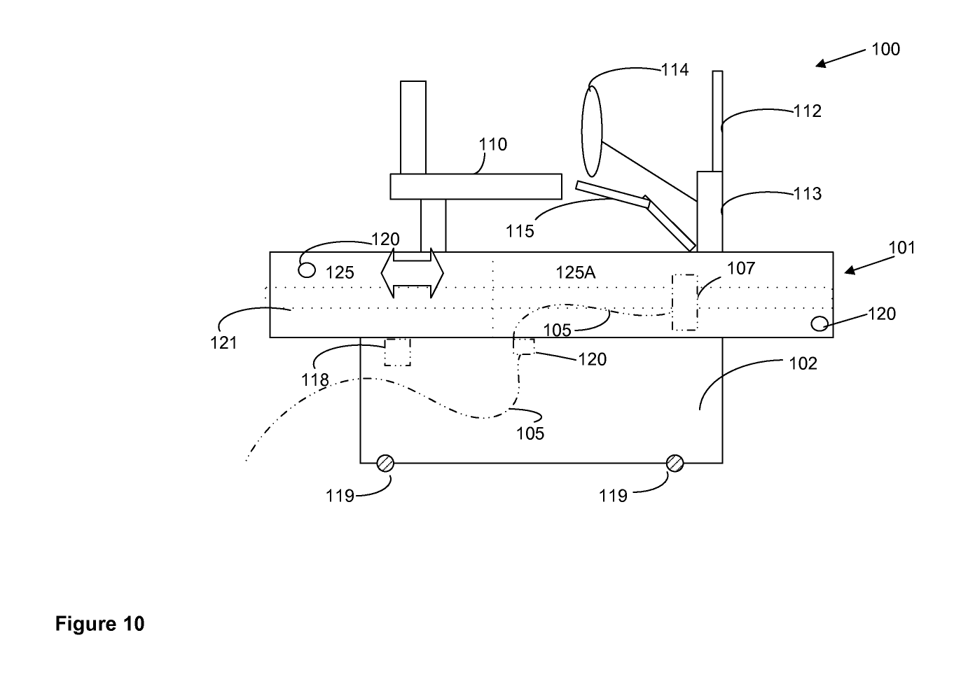

FIG. 10 depicts a driver cockpit generally designated 100 rotatably mounted to a cockpit base 101, according to an embodiment. The driver cockpit includes such driving paraphernalia like seat 110, steering wheel 114, display screen 112, console 113, gear 115, a computer 107 containing a processor, and a motor 118 configured to drive cockpit 101, retractable wheels 119 to render the entire the entire unit mobile, and motion sensors 120 according to an embodiment. In certain embodiments, the driving paraphernalia is implemented modularly having releasably connectable connection configurations, like snap connections, to facilitate convenient exchange of paraphernalia models. For example, a model of a BMW steering wheel by way of a readily exchanged with a model of a Ferrari steering wheel Examples of connection configurations include, inter alia, flex tabs, thread configurations, latch mechanisms, lock configurations or any connection configuration enabling a user to release without tools. Similarly, the driver cockpit 100 in exchangeable and is also releasably connectable with cockpit base 102.

As shown, power is supplied though power line 105 into rotatable electric connection 120 and 120A so as to advantageously enable complete rotation of entire cockpit 100 in accordance with gaming conditions generated by computer 107.

It should be appreciated that in certain embodiments, audio feedback devices, like speakers and their drivers, motion sensors, are also disposed in or on cockpit 100.

All types of gaming feedback data are generated responsively by a single processor into the format appropriate for each respective feedback type; haptic, audio, or visual, according to an embodiment. In other embodiments, a feedback data is generated in a format appropriate for a particular modality and then rendered either digitally or mechanically into feedback data appropriate for other modalities.

In certain embodiments cockpit 100 is implemented telescopically so as to enable cockpit section 125 to nest inside cockpit section 125A when section rolls along tracks 121 disposed on the inner wall of cockpit floor 101, thereby advantageously facilitating transport.

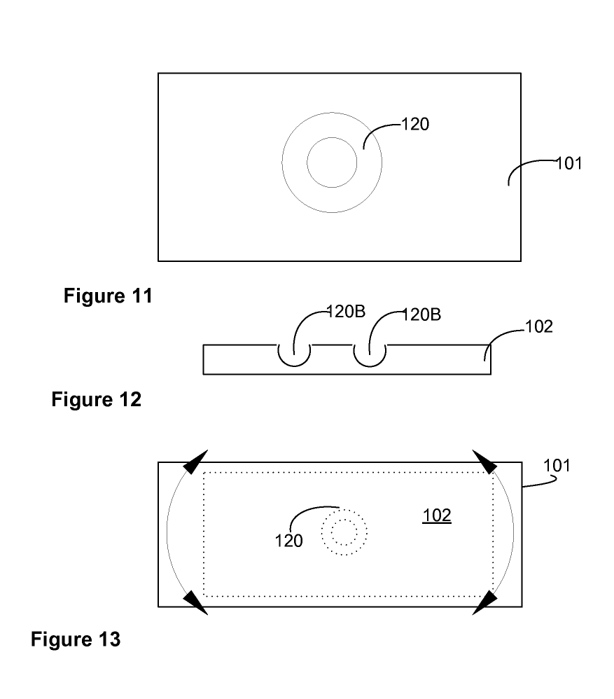

Referring to FIGS. 11 and 12, FIG. 11 is a schematic, bottom view of a circular electrical connector 120 mounted on the underside of a driver cockpit floor 101A, and is seated in circular, electrical groove 120B disposed in a cockpit base 102, according to an embodiment. Such an electrical configuration advantageously allows all electrically powered simulator equipment to be contained within cockpit 100 so that the entire cockpit 100 may rotate together with other haptic feedback, thereby producing a more realistic simulation.

It should be appreciated that configurations in which a circular groove is disposed in the underside of cockpit floor 101A or other electrical configurations providing such functionality are also included within the scope of this invention.

FIG. 13 depicts the rotational capability of the driver cockpit floor 101 on the cockpit base 102, according to an embodiment. It should be appreciated that the axis of rotation of the cockpit 101 on the cockpit base 102 may disposed at any point in the cockpit floor 101.

In certain embodiments the home driving simulator is implemented as a kit that may be assembled in the home by the layman. The rotatable electric connection 120 is configured to snap into grooves 120 (shown in FIG. 12), according to an embodiment.

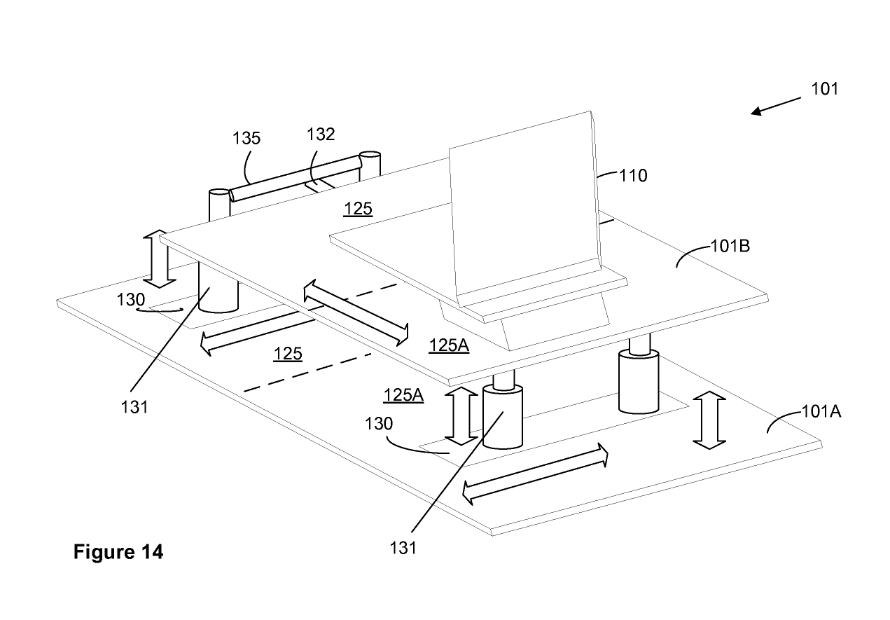

FIG. 14 depicts a schematic, perspective cut-away view of driver cockpit floor 100 and associated pistons 131 slidingly mounted in channels 130 disposed in bottom cockpit floor 102 configured to provide a wide providing motion in accordance with gaming feedback data, according to an embodiment. Each of four pistons 131 are actuated independently by electric actuators in accordance with gaming feedback data emanating from the processor and are therefore able to produce haptic feedback in during rotation to provide the optimal simulation of extreme driving conditions. It should be appreciated that data connections running from computer 107 are not shown. Upper cockpit floor 101B is slidingly mounted on support shaft 132 so as to enable longitudinal haptic feedback like lurching forward or backwards in accordance to gaming feedback data received by lurch actuators. (Not shown)

As noted above in a certain embodiment, cockpit 100 is configured telescopically to facilitate nesting of cockpit section 125 inside section 125A. To collapse cockpit 100, support shaft 132 is released from crossbar 136 and cockpit section 125 is pushed along tracks 121 shown in FIG. 11.

Furthermore, it should be noted that any combination of the features disclosed herewith in are included within the scope of the invention. Accordingly, in some embodiments, in addition to the multiple haptic simulations of cockpit 100 in general, additional haptic simulations are provided through other cockpit paraphernalia in addition typical audio and visual feedback of driving conditions.

It should be appreciated that the driving simulator is implementable as various types of motor vehicles, including, inter alia, road vehicles, airplanes, helicopters, and boats.

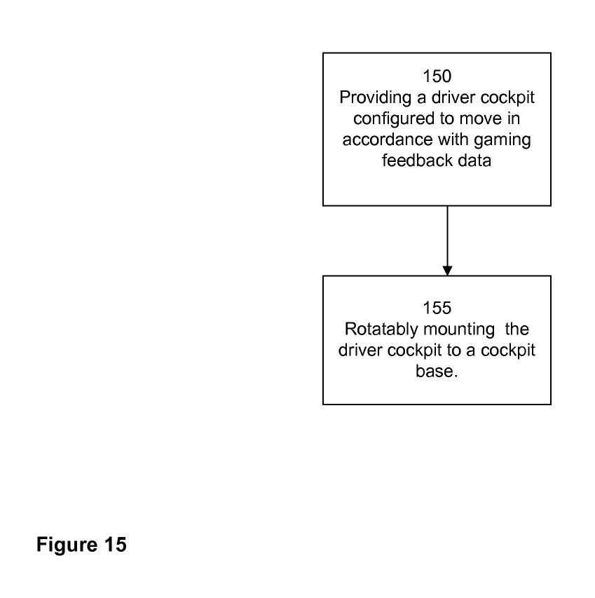

FIG. 15 is a flow chart of a method of construction of a home driving simulator. In step one a driver cockpit configured to move in accordance with gaming feedback data emanating from a processor and a cockpit base is provided. In step 2 the driver cockpit is rotatably mounted onto the cockpit base.

It will be appreciated that the above descriptions are intended only to serve as examples, and that many other possible embodiments are within the scope of the present invention as defined in the appended claims.

What is claimed is:

1. A home driving simulator comprising:
a processor configured to generate gaming feedback data responsively to user input;
a cockpit base; and
a driver cockpit rotatably mounted on the cockpit base, the driver cockpit configured to move in accordance with gaming feedback data emanating from the processor.

2. The home driving simulator of claim 1, wherein the driver cockpit rotatably is mounted on the cockpit base is implemented with at least 180 degrees of rotation capability.

3. The home driving simulator of claim 1, wherein the driver cockpit rotatably is mounted on the cockpit base is implemented with 360 degrees of rotation capability.

4. The home driving simulator of claim 1, wherein the processor is mounted in the driver cockpit.

5. The home driving simulator of claim 1, wherein the processor is in wireless communication with driver cockpit.

6. The home driving simulator of claim 1, further comprising driving paraphernalia configured to move in accordance with gaming feedback data emanating from the processor, driving paraphernalia chosen from the group consisting of a seat, steering wheel, console, and gear shift.

7. A method for constructing a home driving simulator comprising:
providing:
a driver cockpit configured to move in accordance with gaming feedback data emanating from a processor,
a cockpit base; and
rotatably mounting the driver cockpit onto the cockpit base.

8. The method for constructing a home driving simulator of claim 7, wherein the driver cockpit is rotatably mounted on the cockpit base is implemented with at least 180 degrees of rotation capability.

9. The method for constructing a home driving simulator of claim 6, wherein the driver cockpit is rotatably mounted on the cockpit base is implemented with at least 360 degrees of rotation capability.

10. The method for constructing a home driving simulator of claim 7, further comprising mounting the processor in the driver cockpit.

11. A home-driving-simulator kit comprising:
a processor configured to generate gaming feedback data responsively to user input;
a cockpit base,
a driver cockpit configured to be rotatably mounted to the cockpit base such that when mounted the cockpit moves in accordance with gaming feedback data emanating from the processor.

12. The home-driving-simulator kit of claim 11, wherein the driver cockpit has at least 180 degrees of rotation capability when mounted on the cockpit base.

13. The home-driving-simulator kit of claim 11, wherein the driver cockpit has 360 degrees of rotation capability when mounted on the cockpit base.

14. The home-driving-simulator kit of claim 11, wherein the processor is configured to be mounted in the driver cockpit.

15. The home-driving-simulator kit of claim 11, wherein the processor is configured to be in wireless communication in the driver cockpit.
